(19) United States
(12) Patent Application Publication
(10) Pub. No.: US 2008/0007660 A1
(43) Pub. Date: Jan. 10, 2008

(54) IMAGE DISPLAY DEVICE

(75) Inventors: Satoshi KINOSHITA, Matsumoto-shi (JP); Akira SHINBO, Shiojiri-shi (JP); Eiji MORIKUNI, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/689,273

(22) Filed: Mar. 21, 2007

(30) Foreign Application Priority Data
Jul. 6, 2006 (JP) 2006-186459

(51) Int. Cl. H04N 9/31

(52) U.S. Cl. 348/744; 348/E09.025

(57) ABSTRACT

An image display device includes: a projecting section; an image forming section having an image forming plane on which light projected from the projecting section is focused and where an image is formed by diffuse-reflection of the light that has been focused on the image forming plane; and an image providing section configured to transmit the light diffuse-reflected by the image forming section to provide the image formed on the image forming plane to the viewer.

### BACKGROUND

1. Technical Field

The present invention relates to an image display device that projects images.

2. Related Art

Projectors (projection display devices) which project enlarged images on a screen are often used as image display devices for displaying images on large screens. The projectors generally use high-output light sources to provide bright projection images, as described in JP-A-2004-70298 and JP-A-2004-348078.

However, although the known projectors are intended to provide bright projection images, they are not yet sufficient to provide bright projection images using a high-output light source.

### SUMMARY

An advantage of some aspects of the invention is to provide a technique of achieving a new structure of a projector image display device, and in particular, achieving a structure suitable for providing bright projection images using a high-output light source.

An image display device according to an aspect of the invention includes: a projecting section; an image forming section having an image forming plane on which light projected from the projecting section is focused and where an image is formed by diffuse-reflection of the light that has been focused on the image forming plane; and an image providing section configured to transmit the light diffuse-reflected by the image forming section to provide the image formed on the image forming plane to the viewer.

With this structure, a new structure of a projector image forming device and a structure suitable for providing bright projection images with a high-output light source can be achieved.

It is preferable that the light source of the light emitted from the projecting section be a semiconductor laser light source. This arrangement allows projection of bright images.

It is preferable that the image forming section diffuse-reflect the light emitted from the projecting section and include an advancing-direction changing structure for guiding the diffuse-reflected light toward the image providing section. This facilitates guiding the light diffuse-reflected by the image forming section toward the image providing section.

It is preferable that the image forming section and the image providing section be disposed substantially in parallel to each other. This facilitates arrangement of the image forming section and the image providing section.

It is preferable that the image display device further include an enclosure in which the projecting section, the image forming section, and the image providing section are disposed; wherein the image forming section be disposed inside a first surface of the enclosure; and the image providing section be disposed on an opening of a second surface of the enclosure in such a manner as to close the opening, the opening being for the light diffuse-reflected by the image forming section to pass through.

This arrangement can prevent entry of viewers into the path of the light projected from the projecting section, and is effective in dust proofing of the interior of the image display device.

### BRIEF DESCRIPTION OF THE DRAWINGS

The invention will be described with reference to the accompanying drawings, wherein like numbers reference like elements.

FIG. 1 is a schematic explanatory diagram of the structure of an image display device according to an embodiment of the invention.

FIG. 2 is a schematic plan view of the structure of the optical system of a projecting section.

FIG. 3 is a schematic enlarged sectional view of part of a projection screen.

FIG. 4 is a schematic explanatory diagram of the structure of an image display device according to a first modification.

FIG. 5 is a schematic explanatory diagram of the structure of an image display device according to a second modification.

FIG. 6 is a schematic explanatory diagram of the structure of an image display device according to a third modification.

### DESCRIPTION OF EXEMPLARY EMBODIMENTS

Modes for carrying out the invention will be described hereinbelow with reference to embodiments.

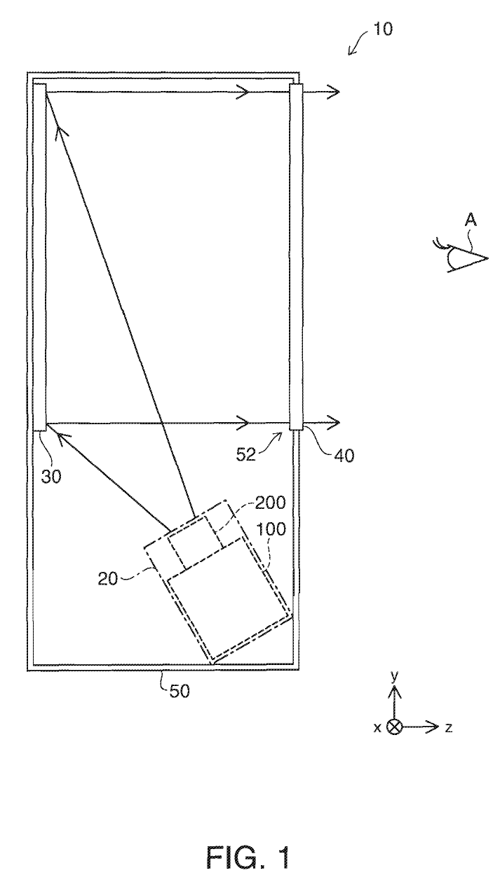

FIG. 1 is a schematic explanatory diagram of the structure of an image display device 10 according to an embodiment of the invention, in which symbols x, y, and z indicate three axes intersecting at right angles with each other. FIG. 1 shows the interior of the image display device 10 as viewed from the left side to the right side, that is, in the direction of −x, with the surface of the enclosure 50 (the surface parallel to the x-y plane) of the image display device 10 as viewed from the direction of -z by a viewer A as the front.

The image display device 10 includes a projecting section 20, a projection screen 30 corresponding to an image forming section of the invention, a light-transmissive screen 40 corresponding to an image providing section of the invention, and an enclosure 50 thereof.

The projection screen 30 is disposed at the upper part (above in the direction of y) of the inner surface (parallel to the x-y plane) of the back (the surface corresponding to a first surface of the invention) of the enclosure 50. The light-transmissive screen 40 is disposed such that it closes an opening 52 in the position of the front (the surface corresponding to a second surface of the invention and parallel to the x-y plane) of the enclosure 50 and opposed to the projection screen 30. The projecting section 20 is tilted on the bottom (the surface parallel to the x-z plane) of the enclosure 50 so as to project light toward the projection screen 30.

The image display device 10 provides an image to the viewer A in such a manner that the light projected from the projecting section 20 is focused on the projection screen 30 and diffuse-reflected by the projection screen 30 to form an image, and the projection light diffuse-reflected by the projection screen 30 passes through the light-transmissive screen 40 to be guided to the viewer A.

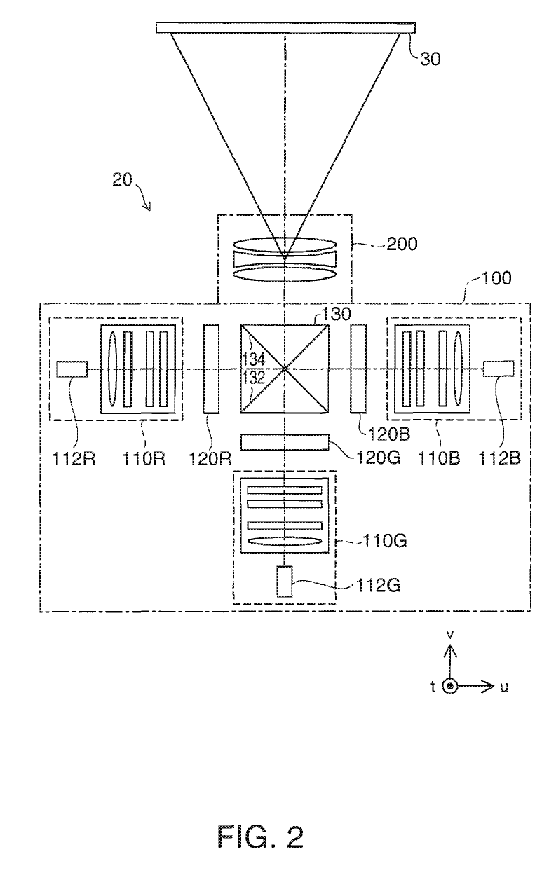

FIG. 2 is a schematic plan view of the structure of the optical system of the projecting section 20, in which symbols u, v, and t indicate three axes intersecting at right angles with each other.

The projecting section 20 has an optical engine 100 and a projection lens 200. The optical engine 100 includes three illumination systems 110R, 110G, and 110B, three liquid-crystal light valves 120R, 120G, and 120B, and a cross dichroic prism 130.

Color lights that exit from the illumination systems 110R, 110G, and 110B are modulated by the liquid-crystal light valves 120R, 120G, and 120B, respectively, according to image information. The color lights modulated by the liquid-crystal light valves 120R, 120G, and 120B are combined by the cross dichroic prism 130. The combined lights are projected onto the projection screen 30 by the projection lens 200.

The illumination systems 110R, 110G, and 110B include light sources 112R, 112G, and 112B which emit red (R), green (G), and blue (B) lights, respectively. The light sources 112R, 112G, and 112B have therein semiconductor lasers which emit R, G, and B lights, respectively, that emit laser lights of the respective colors. The illumination systems 110R, 110G, and 110B thus emit illumination laser lights of R, G, and B colors, respectively, to illuminate the corresponding liquid-crystal light valves 120R, 120G, and 120B.

The liquid-crystal light valves 120R, 120G, and 120B have the function of modulating incident illumination lights according to the respective image information (image signals) of the applied lights to form image light (light that forms an image). The liquid-crystal light valves 120R, 120G, and 120B of the embodiment each include a transmissive liquid-crystal panel which is an electrooptic device and polarizers disposed on the light incident side and the light exiting side thereof. The polarizer on the light incident side of the liquid crystal panel is for increasing the degree of polarization of illumination light. Since the light emitted from semiconductor lasers normally becomes linearly polarized light, the polarizer on the light incident side of the liquid crystal panel may be omitted.

The cross dichroic prism 130 functions as a color-light combining section that combines the light beams of the three colors modulated through the three liquid-crystal light valves 120R, 120G, and 120B to output light that forms a color image. The cross dichroic prism 130 has a red-light reflecting dichroic surface 132 and a blue-light reflecting dichroic surface 134 which are formed substantially in X shape on the interface of four rectangular prisms. The red-light reflecting dichroic surface 132 has a dielectric multilayer that reflects a red light. The blue-light reflecting dichroic surface 134 has a dielectric multilayer that reflects a blue light. The red-light reflecting dichroic surface 132 and the blue-light reflecting dichroic surface 134 combine the three color lights to generate a composite light that presents a color image.

The composite light generated by the cross dichroic prism 130 is directed to the projection lens 200. The projection lens 200 projects the composite light that has exited from the cross dichroic prism 130 so as to form an image on the image forming surface of the projection screen 30. The projection lens 200 may be a telecentric lens.

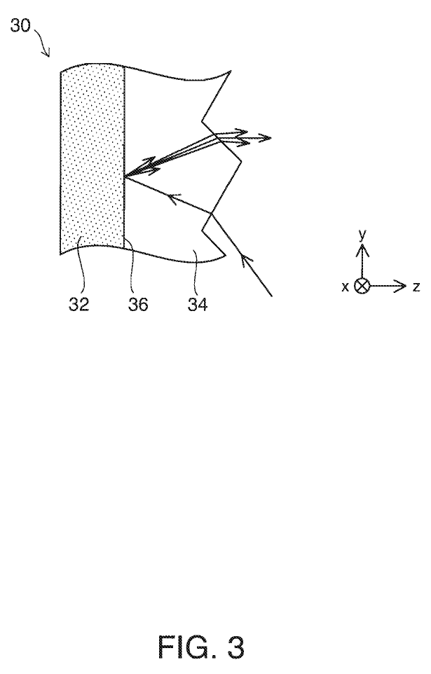

FIG. 3 is a schematic enlarged sectional view of part of the projection screen 30. The projection screen 30 includes a diffuse-reflecting section 32 which functions as a reflection screen and a light-transmissive member (hereinafter, referred to as a Fresnel lens section) 34 disposed on the diffuse-reflecting section 32 and having a Fresnel structure. The diffuse-reflecting section 32 can generally be made of opaque resin containing diffusing fine particles, for example. The Fresnel lens section 34 may be made in such a way that a Fresnel lens is made of a light transmissive resin material, which is then bonded on the diffuse-reflecting section 32 with an optical adhesive.

The diffuse-reflecting section 32 diffuses and reflects the light projected from the projecting section 20 and focused on the surface (hereinafter, referred to as an image-forming surface) 36 of the diffuse-reflecting section 32, thereby forming an image presented by the projected light on the image-forming surface 36.

The Fresnel lens section 34 has the function of changing the direction of travel of the projection light incident on the Fresnel lens section 34 and the projection light exiting from the Fresnel lens section 34 so that the light that is diffuse-reflected by the diffuse-reflecting section 32 is directed to the light-transmissive screen 40. As a result, the projection light that has exited from the projecting section 20 is focused on the image forming surface 36 of the projection screen 30, and is diffuse-reflected by the diffuse-reflecting section 32 and passes through the light-transmissive screen 40 to be guided to the viewer A. Thus, the image formed on the image forming surface 36 of the projection screen 30 is provided to the viewer A through the light-transmissive screen 40.

The reason why the Fresnel lens section 34 is provided on the projection screen 30 is that, without the Fresnel lens section, the light projected from the projecting section 20 enters the image forming surface 36 of the projection screen 30 at a large angle of incidence, as shown in FIG. 1. This often causes the projection light to pass through the diffuse-reflecting section 32 of the projection screen 30 without being reflected thereon and not to reach the viewer A through the light-transmissive screen 40 or causes even the projection light reflected by the diffuse-reflecting section 32 not to reach the viewer A through the light-transmissive screen 40 because of its large angle of reflection (hereinafter, referred to as light loss). As a result, the image provided to the viewer A becomes dark.

On the other hand, with the Fresnel lens section 34 as in this embodiment, the direction of travel of the projection light from the projecting section 20 incident on the Fresnel lens section 34 can be changed so as to decrease the angle of incident on the image forming surface 36, thereby reducing the projection light that is not reflected by the diffuse-reflecting section 32. Moreover, the direction of travel of the light that has been diffuse-reflected by the diffuse-reflecting section 32 can be changed to the direction to the light-transmissive screen 40. This reduces occurrence of the light loss, allowing provision of a light image to the viewer A.

As has been described, the image display device 10 can provide the viewer A with an image formed on the image forming surface 36 in such a manner that the light projected from the projecting section 20 is focused on the image forming surface 36 of the projection screen 30 and is diffuse-reflected by the diffuse-reflecting section 32 to form an image on the image forming surface 36, and the diffuse-reflected light passes through the light-transmissive screen 40 to reach the viewer A.

The image display device 10 of the embodiment can provide a light image (bright image) to the viewer A using the laser light source for the following reason.

Known rear projectors have the same structure as that in which the projection screen 30 of FIG. 1 is replaced with a reflection mirror, and the light-transmissive screen 40 is replaced with a transmissive projection screen, in which light from a projecting section is reflected by the reflection mirror to form an image on the projection screen, and the light is also diffuse-transmitted to form an image on the projection screen, thereby providing an image to the viewer A. When a laser light source is used as the light source of such rear projectors, the projection light from the projecting section is diffused on the projection screen that is nearest to the viewer A. As a result, high-intensity projection light (high-output projection light) will be guided to the viewer A. It is not desirable that such high-intensity projection light be guided to the viewer A but it is desirable to provide a light intensity in view of preferable brightness of the image and intensity of projection light.

Although the image display device 10 of the embodiment uses a laser light source, the projection light is diffuse-reflected by the projection screen 30, and then passes through the light-transmissive screen 40 to reach the viewer A. This has the advantage that damped projection light with an appropriate intensity can be guided to the viewer A.

The image display device 10 of the embodiment has a structure in which its components such as the projecting section 20 and the projection screen 30 are disposed in the enclosure 50, and the light-transmissive screen 40 is disposed so as to close the opening 52 of the enclosure 50. Thus, the light projected from the projecting section 20 passes in the enclosure 50, thereby preventing entry of viewers into the optical path of the projection light, as in front projectors. Moreover, the dustproof performance of the enclosure 50 can be improved.

The image display device 10 can be regarded as a front projector in view of the fact that images are projected onto the projection screen 30. On the other hand, in view of the fact that images formed on the projection screen 30 are not provided directly to the viewer A but the projection light is provided indirectly to the viewer A in such a manner that the projection light is diffuse-reflected by the projection screen 30 and then passes through the light-transmissive screen 40 to reach the viewer A, the image display device 10 can also be regarded as a structure close to a rear projector. Briefly, the image display device 10 of the embodiment has achieved a new structure of a projector image display device.

It is to be understood that the invention is not limited to the foregoing embodiment and various modifications may be made therein without departing from the spirit and scope of the invention as follows.

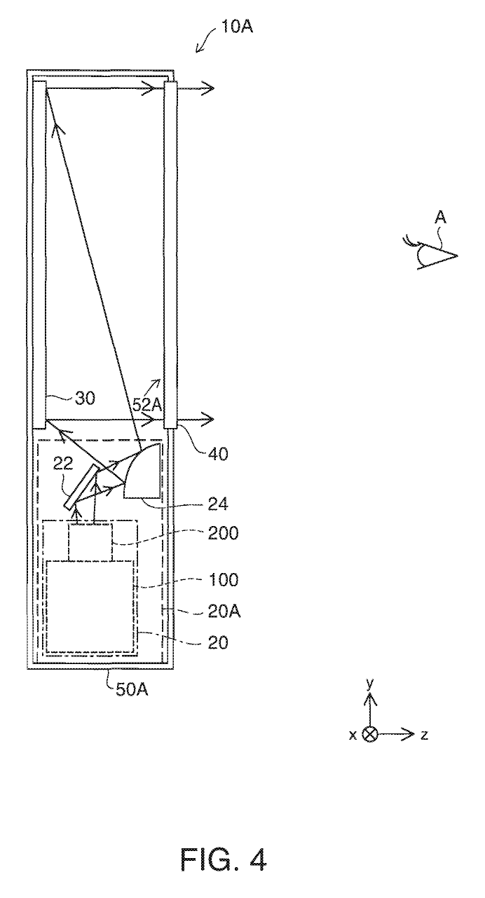

FIG. 4 is a schematic explanatory diagram of the structure of an image display device 10A according to a first modification. As in FIG. 1, FIG. 4 shows the interior of the image display device 10A as viewed from the left side to the right side, that is, in the direction of −x, with the surface of the enclosure 50A (the surface parallel to the x-y plane) of the image display device 10A as viewed in the direction of -z by the viewer A as the front.

The image display device 10A of the first modification is different from the image display device 10 of the embodiment (FIG. 1) in that the projecting section 20 is replaced with a projecting section 20A and the enclosure 50 is replaced with a slim enclosure 50A.

The projecting section 20A includes two first and second mirrors 22 and 24 in addition to the components of the projecting section 20 of the embodiment.

The projecting section 20A is disposed on the bottom of the enclosure 50A so as to project light upward (in the y-direction).

The first mirror 22 is opposed to the projection lens 200 and the second mirror 24 of the projecting section 20A. The first mirror 22 reflects the projection light from the projection lens 200 toward the second mirror 24. The first mirror 22 is a substantially flat parallel plate, on which a reflection layer is formed. The reflection layer may be made of a light reflecting member such as aluminum or another metal or a dielectric multilayer.

The second mirror 24 is disposed inside the front of the enclosure 50A in such a manner as to face the first mirror 22. The second mirror 24 has the function of reflecting the projection light from the first mirror 22 at wide angles in the x-direction or in the y-direction. The second mirror 24 also has the function of directing the projection light toward the projection screen 30. The second mirror 24 may be a mirror having an aspherical curve. The structure of the second mirror 24 is the same as that of the projection mirror described in JP-A-2002-267823. The curved shape of the second mirror 24 allows the projection light to be bent (reflected) at wide angles. This allows the projection light to be advanced at wider angles than only with the projection lens 200. Thus a slim enclosure can be achieved and thus a slim image display device can be achieved.

As in the image display device 10 according to the embodiment, also the image display device 10A of the first modification can provide images to the viewer A in such a manner that the light projected from the projecting section 20A is focused on the projection screen 30, and the light is diffuse-reflected to form an image, and the projection light diffuse-reflected by the projection screen 30 passes through the light-transmissive screen 40 to be guided to the viewer A. Moreover, the image display device 10A can provide a light image to the viewer A using a laser light source. Furthermore, the image display device 10A can prevent entry of viewers into the optical path of the projection light, as in front projectors, and moreover, it has high dustproof performance for the enclosure 50A.

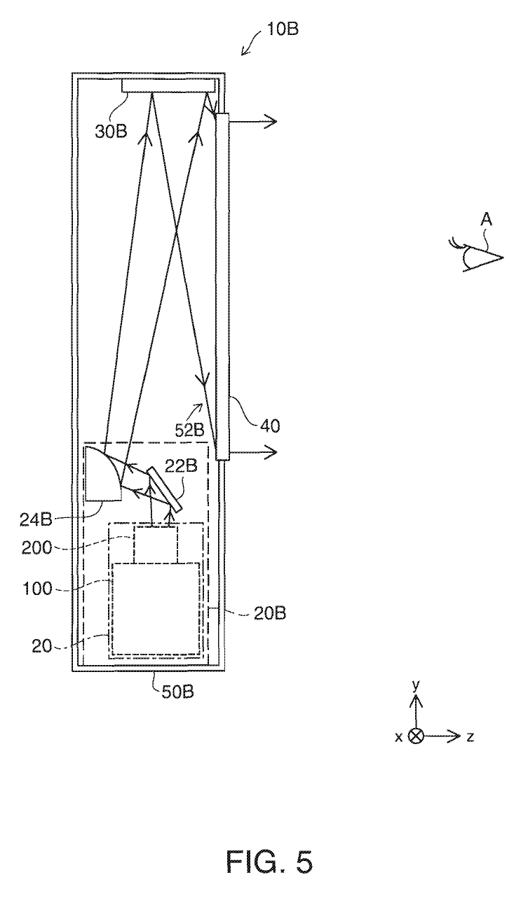

FIG. 5 is a schematic explanatory diagram of the structure of an image display device 10B according to a second modification. As in FIG. 1, FIG. 5 shows the interior of the image display device 10B as viewed from the left side to the right side, that is, in the direction of −x, with the surface of the enclosure 50B (the surface parallel to the x-y plane) of the image display device 10B as viewed in the direction of -z by the viewer A as the front.

The image display device 10B of the second modification has a structure in which the projecting section 20 of the image display device 10 of the embodiment (FIG. 1) is replaced with a projecting section 20B, the enclosure 50 is replaced with a slim enclosure 50B, the projection screen 30 is replaced with a projection screen 30B, and the projection screen 30B is disposed inside the upper surface (the surface corresponding to the second surface of the invention, which is parallel to the x-z plane) of the enclosure 50B.

The projecting section 20B, similar to the projection section 20A of the first modification, includes two first and second mirrors 22B and 24B in addition to the components of the projecting section 20 of the embodiment. However, it is different from the projecting section 20A in that the second mirror 24B is disposed inside the back of the enclosure 50B in such a manner as to face the first mirror 22B, that in accordance with the position of the second mirror 24B, the first mirror 22B is disposed so as to reflect the projection light from the projection lens 200 of the projecting section 20B toward the second mirror 24B, and that the second mirror 24B reflects the projection light from the first mirror 22B toward the projection screen 30B which is disposed not on the back of the enclosure 50B but inside the upper surface of the enclosure 50B.

The projection light that has been focused on and diffuse-reflected by the projection screen 30B is guided toward the light-transmissive screen 40 by the function of a Fresnel lens (not shown).

Also with the image display device 10B of the second modification, the light can be projected at wider angle than only with the projection lens 200, the enclosure can be made slim, and thus a slim image display device can be achieved.

As shown in FIG. 5, in the image display device 10B of the second modification, the angle of incidence of the projection light from the projection screen 30B on the light-transmissive screen 40 is large as a whole. Accordingly, little projection light is guided to the viewer A (in the z-direction) to cause deviation in the image viewing angle of the viewer A. Therefore, it is preferable to provide a Fresnel lens section to either of the light-incident side or the light-exiting side of the light-transmissive screen 40, as with the projection screen 30, to thereby guide the light incident on the light-transmissive screen 40 to the viewer A (in the z-direction).

As in the image display device 10 according to the embodiment, also the image display device 10B of the second modification can provide images to the viewer A in such a manner that the light projected from the projecting section 20B is focused on the projection screen 30B, and the light is diffuse-reflected to form an image, and the projection light diffuse-reflected by the projection screen 30B passes through the light-transmissive screen 40. Moreover, the image display device 10B can provide a light image to the viewer A using a laser light source. Furthermore, the image display device 10B can prevent entry of viewers into the optical path of the projection light, as in front projectors, and moreover, it has high dustproof performance for the enclosure 50B.

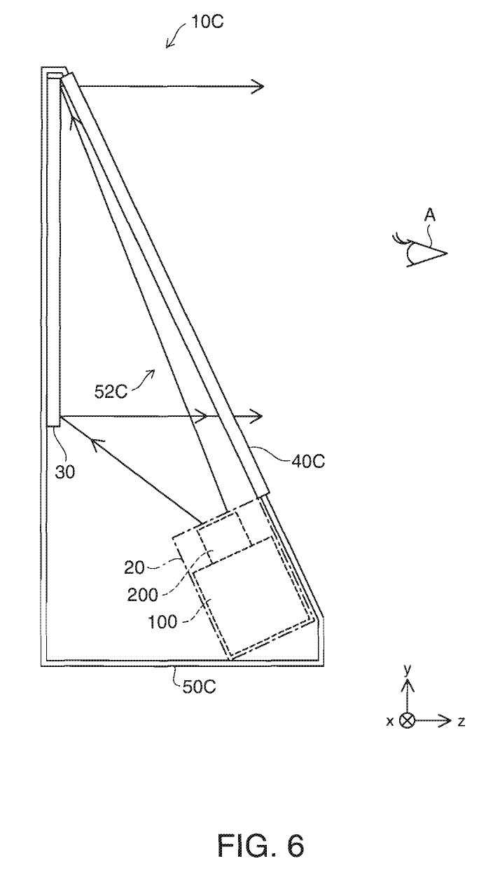

FIG. 6 is a schematic explanatory diagram of the structure of an image display device 10C according to a third modification. As in FIG. 1, FIG. 6 shows the interior of the image display device 10C as viewed from the left side to the right side, that is, in the direction of −x, with the surface of the image display device 10C as viewed in the direction of -z by the viewer A as the front.

The image display device 10C of the third modification has a structure in which an opening 52C whose upper part is inclined to the back is provided at the front (the surface corresponding to the second surface of the invention) of an enclosure 50C and a light-transmissive screen 40C is disposed so as to close the opening 52C, which is different from the image display device 10 of the embodiment in which the projection screen 30 and the light-transmissive screen 40 are disposed in parallel. Specifically, the light-transmissive screen 40C is tilted along the outer side of the range of projection from the projecting section 20 adjacent to the viewer A. Since the light-transmissive screen 40C is thus disposed, the image display device 10C can be more compact than the image display device 10 of the embodiment.

As in the image display device 10 according to the embodiment, also the image display device 10C of the third modification can provide images to the viewer A in such a manner that the light projected from the projecting section 20 is focused on the projection screen 30, and the light is diffuse-reflected to form an image, and the projection light diffuse-reflected by the projection screen 30 passes through the light-transmissive screen 40C. Moreover, the image display device 10C can provide a light image to the viewer A using a laser light source. Furthermore, the image display device 10C can prevent entry of viewers into the optical path of the projection light, as in front projectors, and moreover, it has high dustproof performance for the enclosure 50C.

The light-transmissive screens of the image display devices 10A and 10B of the first and second modifications can also be tilted.

In the embodiment and the first modification, either of the light incident surface or the light exiting surface of the light-transmissive screen may have a light-transmissive member with a Fresnel structure, as in the second modification. This increases the image viewing angle of the viewer A and improves the contrast.

In the embodiment and the modifications, the Fresnel light-transmissive member provided on the projection screen or the light-transmissive screen may be any of various optical devices having a light-traveling-direction changing structure such as a lenticular light transmissive member. In other words, the Fresnel light-transmissive member may be any optical device that can change the direction of travel of incident light or exiting light to a desired direction.

Although the projection screen 30 of the embodiment has the diffuse-reflecting section 32 and the Fresnel lens section 34, a projection screen may be provided which has a reflecting section and a Fresnel lens section having a diffusing function by the microscopic roughness on the surface.

Although the light source for use in the illumination system of the embodiment is a laser light source, another RGB illumination optical system may be provided which emits RGB color lights using another light source such as a high-pressure mercury vapor lamp, a halogen lamp, or a light emitting diode (LED).

Although the embodiment uses a projector that has liquid-crystal light valves in a projecting section, the light valves each having a light-transmissive liquid-crystal panel as an electrooptic device, a projector that has liquid-crystal light valves using a reflection liquid crystal panel may be used as a projection section. A projector using a Texas Instrument's digital micromirror device (DMD) may be used as a projecting section. Alternatively, a scanning projector that projects images by scanning beams may be used as a projecting section.

The entire disclosure of Japanese Patent Application No. 2006-186459, filed Jul. 6, 2006 is expressly incorporated by reference herein.

What is claimed is:

1. An image display device comprising:
a projecting section;
an image forming section having an image forming plane on which light projected from the projecting section is focused and where an image is formed by diffuse-reflection of the light that has been focused on the image forming plane; and
an image providing section configured to transmit the light diffuse-reflected by the image forming section to provide the image formed on the image forming plane to the viewer.

2. The image display device according to claim 1, wherein
the light source of the light emitted from the projecting section is a semiconductor laser light source.

3. The image display device according to claim 1, wherein
the image forming section diffuse-reflects the light emitted from the projecting section and includes an advancing-direction changing structure for guiding the diffuse-reflected light toward the image providing section.

4. The image display device according to claim 1, wherein
the image forming section and the image providing section are disposed substantially in parallel to each other.

5. The image display device according to claim 1, further comprising:
an enclosure in which the projecting section, the image forming section, and the image providing section are disposed; wherein
the image forming section is disposed inside a first surface of the enclosure; and
the image providing section is disposed on an opening of a second surface of the enclosure in such a manner as to close the opening, the opening being for the light diffuse-reflected by the image forming section to pass through.
